(19) United States
(12) Patent Application Publication
(10) Pub. No.: US 2019/0091924 A1
(43) Pub. Date: Mar. 28, 2019

(54) Apparatus For Producing Three-Dimensional Shaped Article And Method For Producing Three-Dimensional Shaped Article

(71) Applicant: Seiko Epson Corporation, Tokyo (JP)

(72) Inventors: Akihiko TSUNOYA, Okaya (JP); Eiji OKAMOTO, Matsumoto (JP)

(21) Appl. No.: 16/139,504

(22) Filed: Sep. 24, 2018

(30) Foreign Application Priority Data
Sep. 25, 2017 (JP) 2017-183830

(51) Int. Cl. B29C 64/165; B29C 64/295; B29C 64/393; B29C 64/209

(52) U.S. Cl. CPC B29C 64/165; B29C 64/295; B33Y 10/00; B29C 64/209; B29C 64/393

(57) ABSTRACT

Provided is an apparatus for producing a three-dimensional shaped article in which the three-dimensional shaped article is produced by stacking layers, the apparatus including: an ejecting section capable of ejecting a flowable material that contains a powder, a solvent, and a binder which constitute the three-dimensional shaped article, based on data; a heating section for heating the flowable material ejected from the ejecting section; and a controlling section for controlling the ejecting section and the heating section, in which the controlling section divides data of the layer for one layer of the three-dimensional shaped article, out of the data, into a plurality of divided pieces of data, and alternately repeats ejection of the flowable material from the ejecting section and heating by the heating section, based on the divided pieces of data, to form the layer for one layer of the three-dimensional shaped article.

This application claims priority under 35 U.S.C. § 119 to Japanese Patent Application No. 2017-183830 filed on Sep. 25, 2017, the entire disclosure of which is expressly incorporated by reference herein.

### BACKGROUND

### 1. Technical Field

The present invention relates to an apparatus for producing a three-dimensional shaped article and a method for producing a three-dimensional shaped article.

### 2. Related Art

In the related art, a variety of methods for producing a three-dimensional shaped article and apparatuses for producing a three-dimensional shaped article have been used. Among them, there are a method for producing a three-dimensional shaped article and an apparatus for producing a three-dimensional shaped article, in which the three-dimensional shaped article is produced by stacking a plurality of layers using a flowable material.

For example, JP-A-2008-279418 discloses a method for producing a three-dimensional shaped article, in which the three-dimensional shaped article can be produced by discharging a paste (flowable material) from a nozzle such that a plurality of layers are stacked.

In a case of producing a three-dimensional shaped article by stacking a plurality of layers using a flowable material that contains a powder, a solvent, and a binder which constitute a three-dimensional shaped article, there are some cases where, due to volatilization of the solvent or the like, distribution of the solvent and the binder is biased in a three-dimensional manner, and a place where the binder is insufficient in the layer is generated, thereby resulting in a damaged three-dimensional shaped article. For example, in a case where the distribution of the binder is greatly biased toward a central region of a bottom surface of the three-dimensional shaped article, the binder becomes insufficient at a surface layer part and binding force is decreased. In such a state, the three-dimensional shaped article is damaged.

### SUMMARY

An advantage of some aspects of the invention is that in a case where the three-dimensional shaped article is produced by stacking a plurality of layers using a flowable material that contains a powder, a solvent, and a binder, the three-dimensional shaped article is prevented from being damaged due to the binder being biased in a three-dimensional manner.

According to an aspect of the invention, there is provided an apparatus for producing a three-dimensional shaped article in which the three-dimensional shaped article is produced by stacking layers, the apparatus including: an ejecting section capable of ejecting a flowable material that contains a powder, a solvent, and a binder which constitute the three-dimensional shaped article, based on data; a heating section for heating the flowable material ejected from the ejecting section; and a controlling section for controlling the ejecting section and the heating section, in which the controlling section divides data of the layer for one layer of the three-dimensional shaped article, out of the data, into a plurality of divided pieces of data, and alternately repeats ejection of the flowable material from the ejecting section and heating by the heating section, based on the divided pieces of data, to form the layer for one layer of the three-dimensional shaped article.

In this configuration, the data of the layer for one layer of the three-dimensional shaped article is divided into a plurality of divided pieces of data, and the ejection of the flowable material from the ejecting section and the heating by the heating section based on the divided pieces of data are alternately repeated to form the layer for one layer of the three-dimensional shaped article. That is, the data of the layer for one layer is divided into a plurality of divided pieces of data to make an ejection density of the flowable material low (to reduce moving efficiency of the binder), and at the same time, every time the flowable material with a low ejection density is formed, the flowable material is heated (to make the binder difficult to move). Therefore, it is possible to prevent the binder from being biased in a three-dimensional manner, and it is possible to prevent the three-dimensional shaped article from being damaged.

In the apparatus for producing a three-dimensional shaped article, the controlling section may divide the data of the layer for one layer into two divided pieces of data such that masses of the flowable material having a predetermined threshold or less are disposed in a staggered manner with one another.

In this configuration, the data of the layer for one layer is divided into two divided pieces of data such that masses of the flowable material having a predetermined threshold or less are disposed in a staggered manner with one another. That is, the layer for one layer of the three-dimensional shaped article is formed while reducing a movable range of the binder. Therefore, it is possible to effectively prevent the binder from being biased in a three-dimensional manner, and it is possible to effectively prevent the three-dimensional shaped article from being damaged.

In the apparatus for producing a three-dimensional shaped article, the ejecting section may be able to discharge the flowable material in a droplet shape.

In this configuration, the ejecting section is capable of discharging the flowable material in a droplet shape. Thus, it is possible to densely form a layer for one layer of the three-dimensional shaped article.

In the apparatus for producing a three-dimensional shaped article, for each data of the layer for one layer, the controlling section may be able to make a determination whether the data is to be divided based on at least one of an ejection density and an ejection position of the flowable material.

In this configuration, for each the data of the layer for one layer, the controlling section is capable of making a determination whether the data is to be divided based on at least one of the ejection density and the ejection position of the flowable material. Therefore, in a case where the binder does not easily move without dividing the data, such as a case where an ejection density of the flowable material is low, priority can be given to a production efficiency (production speed) of the three-dimensional shaped article.

In the apparatus for producing a three-dimensional shaped article, a heating temperature of the heating section may be equal to or lower than a decomposition temperature of the binder.

In this configuration, the heating temperature of the heating section is equal to or lower than the decomposition temperature of the binder. Thus, it is possible to prevent the three-dimensional shaped article from being damaged due to decomposition of the binder at the time of heating.

In the apparatus for producing a three-dimensional shaped article, in a case where the ejection of the flowable material and the heating by the heating section are repeated, the controlling section may cause at least 50% of the solvent contained in the flowable material to be volatilized due to the heating by the heating section, and then cause the flowable material to be ejected from the ejecting section.

In this configuration, in a case where the ejection of the flowable material and the heating by the heating section are repeated, at least 50% of the solvent contained in the flowable material is volatilized due to the heating by the heating section, and then the flowable material is ejected from the ejecting section. That is, after making the binder difficult to move, the flowable material is ejected from the ejecting section. Therefore, it is possible to effectively prevent the binder from being biased in a three-dimensional manner, and it is possible to effectively prevent the three-dimensional shaped article from being damaged.

According to another aspect of the invention, there is provided a method of producing a three-dimensional shaped article in which the three-dimensional shaped article is produced by stacking layers using an apparatus for producing a three-dimensional shaped article which includes an ejecting section capable of ejecting a flowable material that contains a powder, a solvent, and a binder which constitute the three-dimensional shaped article, based on data; a heating section for heating the flowable material ejected from the ejecting section; and a controlling section for controlling the ejecting section and the heating section, the method including: dividing data of the layer for one layer of the three-dimensional shaped article, out of the data, into a plurality of divided pieces of data; and alternately repeating ejection of the flowable material from the ejecting section and heating by the heating section, based on the divided pieces of data, to form the layer for one layer of the three-dimensional shaped article.

In this configuration, the data of the layer for one layer of the three-dimensional shaped article is divided into a plurality of divided pieces of data, and the ejection of the flowable material from the ejecting section and the heating by the heating section are alternately repeated, based on the divided pieces of data, to form the layer for one layer of the three-dimensional shaped article. That is, the data of the layer for one layer is divided into a plurality of divided pieces of data to make an ejection density of the flowable material low (to reduce moving efficiency of the binder), and at the same time, every time the flowable material with a low ejection density is formed, the flowable material is heated (to make the binder difficult to move). Therefore, it is possible to prevent the binder from being biased in a three-dimensional manner, and it is possible to prevent the three-dimensional shaped article from being damaged.

### BRIEF DESCRIPTION OF THE DRAWINGS

The invention will be described with reference to the accompanying drawings, wherein like numbers reference like elements.

FIG. 1 is a schematic configuration diagram showing a configuration of a production apparatus for a three-dimensional shaped article according to an embodiment of the invention.

FIG. 2 is an enlarged view of a portion II shown in FIG. 1.

FIG. 3 is a schematic configuration diagram showing a configuration of a production apparatus for a three-dimensional shaped article according to an embodiment of the invention.

FIG. 4 is an enlarged view of a portion IV shown in FIG. 3.

FIG. 5 is a schematic perspective view of a head base according to an embodiment of the invention.

FIG. 6 is a plan view conceptually explaining a relationship between a disposition of head units and a formation form of a three-dimensional shaped article according to an embodiment of the invention.

FIG. 7 is a plan view conceptually explaining the relationship between the disposition of head units and the formation form of a three-dimensional shaped article according to an embodiment of the invention.

FIG. 8 is a plan view conceptually explaining the relationship between the disposition of head units and the formation form of a three-dimensional shaped article according to an embodiment of the invention.

FIG. 9 is a schematic diagram conceptually explaining the formation form of a three-dimensional shaped article.

FIG. 10 is a schematic diagram conceptually explaining the formation form of a three-dimensional shaped article.

FIG. 11 is a schematic diagram showing an example of another disposition of head units disposed on a head base.

FIG. 12 is a schematic diagram showing an example of another disposition of head units disposed on a head base.

FIG. 13 is a schematic view conceptually explaining disposition of a flowable material in a case where the flowable material is ejected based on divided pieces of data by using an apparatus for producing a three-dimensional shaped article according to one embodiment of the invention.

FIG. 14 is a schematic view conceptually explaining disposition of a flowable material in a case where the flowable material is ejected based on divided pieces of data by using an apparatus for producing a three-dimensional shaped article according to one embodiment of the invention.

FIG. 15 is a flowchart of a method of producing a three-dimensional shaped article according to an example of the invention.

FIG. 16 is a flowchart of a method of producing a three-dimensional shaped article according to another example of the invention.

### DESCRIPTION OF EXEMPLARY EMBODIMENTS

Embodiments according to the invention will be described below with reference to the drawings.

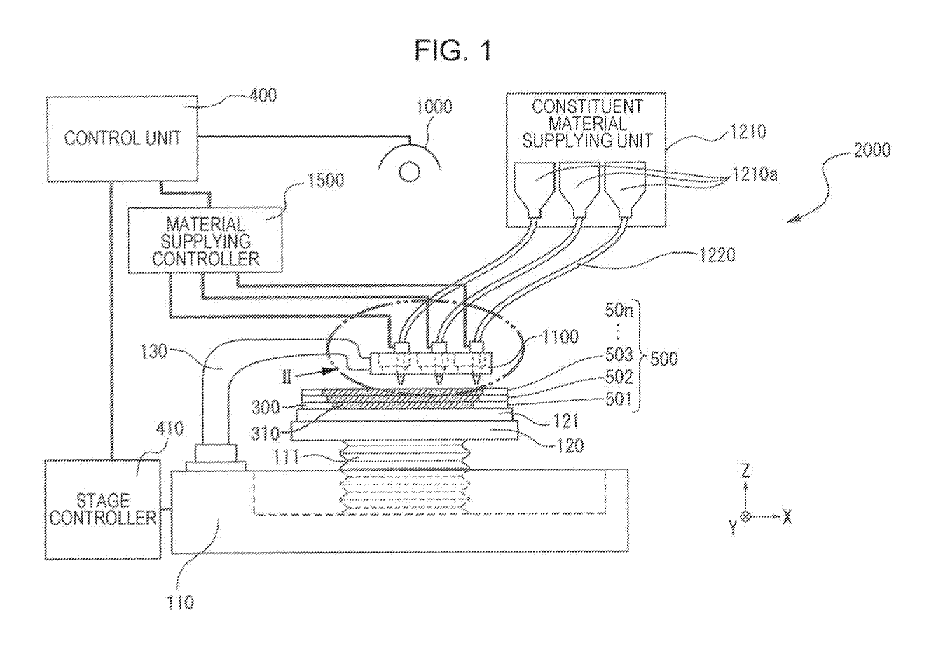

FIGS. 1 to 4 are schematic configuration diagrams showing a configuration of a production apparatus for a three-dimensional shaped article according to an embodiment of the invention.

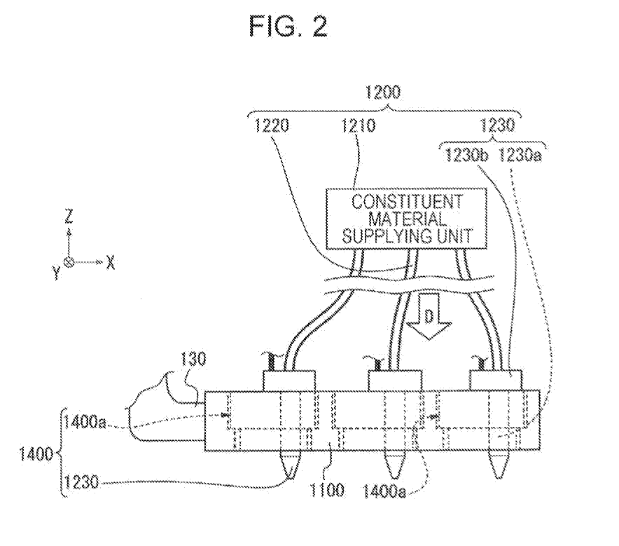

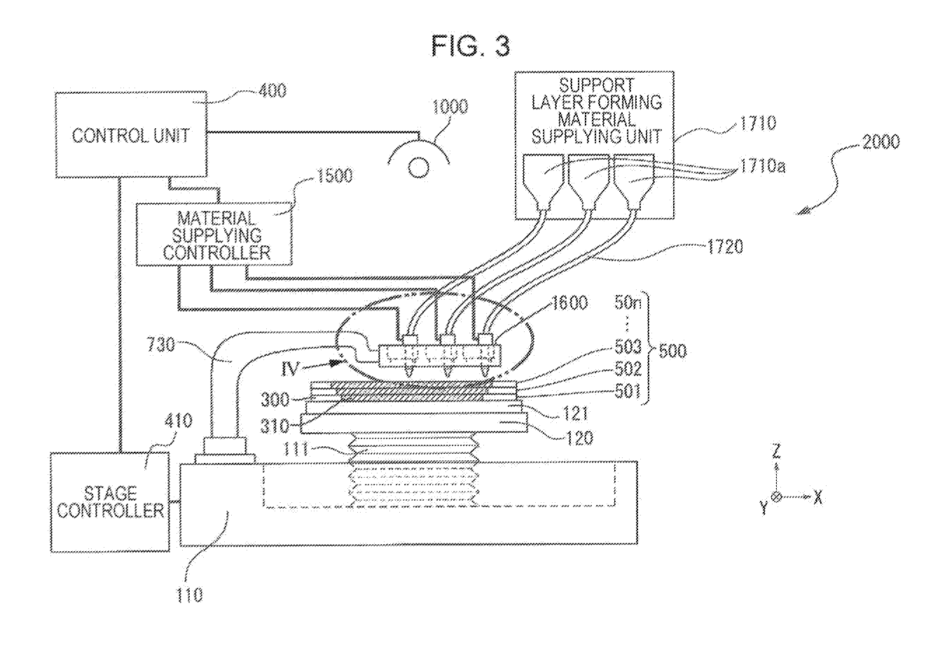

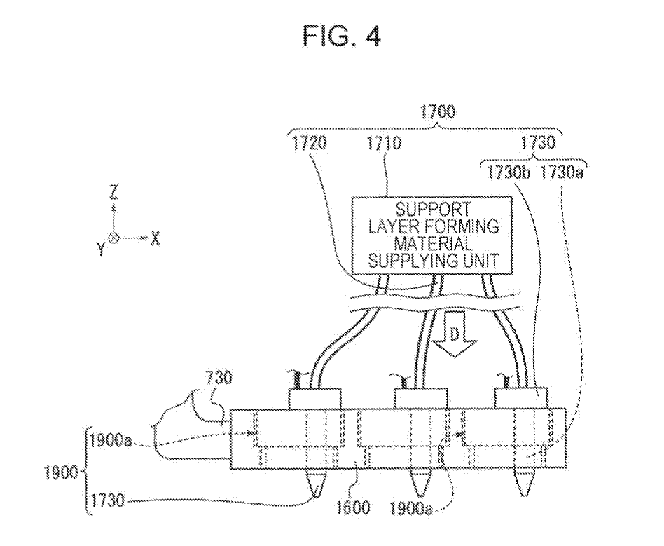

In these cases, the production apparatus for a three-dimensional shaped article of the present embodiment is provided with two types of material supplying sections (head bases). Among them, FIGS. 1 and 2 are diagrams showing only one material supplying section (material supplying section for supplying a constituent material of a three-dimensional shaped article). In addition, FIGS. 3 and 4 are diagrams showing only another material supplying section (a material supplying section for supplying a support layer forming material for forming the support layer that supports a three-dimensional shaped article at the time of forming the three-dimensional shaped article).

In the specification, “three-dimensional shaping” means forming a so-called stereoscopically shaped article, and is, for example, intended to include also forming a flat plate shape, the so-called two-dimensional shape, into a shape in which a thickness is made therefor. Further, “support” is intended to include not only providing support from a lower side, but also providing support from a lateral side and in some cases providing support from an upper side.

Further, the constituent material of this example is a three-dimensional shaping paste (flowable material) that contains powder particles, a solvent, and a binder that is soluble in the solvent which constitute a three-dimensional shaped article. The support layer forming material of this example is a three-dimensional shaping paste (flowable material) that contains support layer forming particles, a solvent, and a binder that is soluble in the solvent.

A three-dimensional shaped article production apparatus 2000 (hereinafter referred to as a formation apparatus 2000) shown in FIGS. 1 and 3 is provided with a base 110 and a stage 120 that is configured such that a drive device 111 as drive means provided in the base 110 allows the stage 120 to move in the X, Y, or Z direction, or to be driven along a rotational direction about the Z axis.

As shown in FIGS. 1 and 2, there is provided a head base support 130 having one end portion fixed to the base 110 and the other end portion in which a head base 1100 is held and fixed, the head base 1100 holding a plurality of head units 1400, each head unit 1400 being provided with a constituent material discharging section 1230 for discharging the constituent material.

Further, as shown in FIGS. 3 and 4, there is provided a head base support 730 having one end portion fixed to the base 110 and the other end portion in which a head base 1600 is held and fixed, the head base 1600 holding a plurality of head units 1900, each head unit 1900 being provided with a support layer forming material discharging section 1730 for discharging a support layer forming material that supports a three-dimensional shaped article.

In these cases, the head base 1100 and the head base 1600 are provided in parallel in the XY plane.

It is noted that the constituent material discharging section 1230 and the support layer forming material discharging section 1730 have the same configuration. However, the invention is not limited to such a configuration.

On the stage 120, layers 501, 502 and 503 are formed in the process of forming a three-dimensional shaped article 500. A thermal energy is irradiated by an electromagnetic wave irradiating section 1000 or the like for forming the three-dimensional shaped article 500. Thus, in order to provide protection against the heat of the stage 120, a sample plate 121 having heat resistance may be used and the three-dimensional shaped article 500 may be formed on the sample plate 121. The sample plate 121 of the present embodiment is the one made of metal that is robust and easy to produce. However, by using, for example, a ceramic plate as the sample plate 121, it is possible to obtain high heat resistance. Also, the ceramic plate can also exhibit low reactivity with the constituent material of the three-dimensional shaped article 500 to be degreased, sintered, or the like, thereby preventing the three-dimensional shaped article 500 from being deteriorated. In FIGS. 1 and 3, three layers of layers 501, 502, and 503 are illustrated for convenience of description. However, stacking is performed until a desired shape of the three-dimensional shaped article 500 is obtained (until layer 50n is stacked in FIGS. 1 and 3).

In this case, each of the layers 501, 502, 503, . . . , 50n includes the support layer 300 formed of the support layer forming material which is discharged from the support layer forming material discharging section 1730, and the constituent layer 310 formed of the constituent material which is discharged from the constituent material discharging section 1230.

It is noted that the formation apparatus 2000 of the present embodiment is a production apparatus for a three-dimensional shaped article which is capable of forming the layers 501, 502, 503, . . . , 50n, and a plurality of layers by using a support layer forming material in addition to the constituent material of the three-dimensional shaped article 500. However, the formation apparatus 2000 may be a production apparatus for a three-dimensional shaped article which is capable of forming the plurality of layers without using the support layer forming material.

Further, FIG. 2 is a conceptual diagram enlarging the portion II showing the head base 1100 shown in FIG. 1. As shown in FIG. 2, the head base 1100 holds a plurality of head units 1400. Although will be described in detail later, one head unit 1400 is configured such that the constituent material discharging section 1230 provided in the constituent material supplying device 1200 is held by a holding tool 1400a. The constituent material discharging section 1230 includes a discharging nozzle 1230a, and a discharging drive section 1230b for discharging the constituent material from the discharging nozzle 1230a by a material supplying controller 1500.

FIG. 4 is a conceptual diagram enlarging the portion IV showing the head base 1600 shown in FIG. 3. As shown in FIG. 4, the head base 1600 holds a plurality of head units 1900. The head unit 1900 is configured such that the support layer forming material discharging section 1730 provided in a support layer forming material supplying device 1700 is held by a holding tool 1900a. The support layer forming material discharging section 1730 includes a discharging nozzle 1730a, and a discharging drive section 1730b for discharging the support layer forming material from the discharging nozzle 1730a by the material supplying controller 1500.

As shown in FIGS. 1 and 2, the constituent material discharging section 1230 is connected by a supplying tube 1220 to the constituent material supplying unit 1210 that contains a constituent material corresponding to each of the head units 1400 held in the head base 1100. A predetermined amount of constituent material is supplied from the constituent material supplying unit 1210 to the constituent material discharging section 1230. In the constituent material supplying unit 1210, the constituent material of the three-dimensional shaped article 500 shaped by the formation apparatus 2000 according to the present embodiment is contained in a constituent material container 1210a, and the individual constituent material containers 1210a are connected by the supplying tubes 1220 to the individual constituent material discharging sections 1230. As such, by providing the individual constituent material containers 1210a, a plurality of different types of materials can be supplied from the head base 1100.

As shown in FIGS. 3 and 4, the support layer forming material discharging section 1730 is connected by a supplying tube 1720 to a support layer forming material supplying unit 1710 that contains support layer forming material corresponding to each of the head units 1900 held in the head base 1600. A predetermined amount of support layer forming material is supplied from the support layer forming material supplying unit 1710 to the support layer forming material discharging section 1730. In the support layer forming material supplying unit 1710, the support layer forming material that constitutes the support layer at the time of shaping the three-dimensional shaped article 500 is contained in a support layer forming material container 1710a, and the individual support layer forming material containers 1710a are connected by the supplying tubes 1720 to the individual support layer forming material discharging sections 1730. As such, by providing the individual support layer forming material containers 1710a, a plurality of different types of support layer forming materials can be supplied from the head base 1600.

Each of the three-dimensional shaping pastes as the constituent material and the support layer forming material used in the formation apparatus 2000 of this example will be described in detail later.

The formation apparatus 2000 includes a control unit 400 as control means for controlling the above-described stage 120, the constituent material discharging section 1230 provided in the constituent material supplying device 1200, and the support layer forming material discharging section 1730 provided in the support layer forming material supplying device 1700, based on the data for shaping the three-dimensional shaped article 500 output from a data output device such as a personal computer (not shown). The control unit 400 also functions as a controlling section that controls the stage 120 and the constituent material discharging section 1230 such that they are driven and operated in a cooperative manner, and controls the stage 120 and the support layer forming material discharging section 1730 such that they are driven and operated in a cooperative manner.

For the stage 120 movably provided on the base 110, a signal for controlling start and stop of movement, movement direction, movement amount, movement speed, and the like of the stage 120 is generated in a stage controller 410 based on a control signal from the control unit 400, and sent to the drive device 111 provided on the base 110, thereby causing the stage 120 to move in the X, Y, or Z direction shown in the drawing. In the constituent material discharging section 1230 provided in the head unit 1400, a signal for controlling an amount of the material discharged from the discharging nozzle 1230a and the like in the discharging drive section 1230b provided in the constituent material discharging section 1230 is generated in the material supplying controller 1500 based on a control signal from the control unit 400, and the generated signal causes a predetermined amount of the constituent material to be discharged from the discharging nozzle 1230a.

Similarly, in the support layer forming material discharging section 1730 provided in the head unit 1900, a signal for controlling an amount of the material discharged from the discharging nozzle 1730a and the like in the discharging drive section 1730b provided in the support layer forming material discharging section 1730 is generated in the material supplying controller 1500 based on a control signal from the control unit 400, and the generated signal causes a predetermined amount of the support layer forming material to be discharged from the discharging nozzle 1730a.

In addition, the electromagnetic wave irradiating section 1000 is also configured to be capable of irradiating electromagnetic waves toward the layers 501, 502, 503, . . . , 50n of the three-dimensional shaped article 500 formed on the stage 120 (sample plate 121) under control of the control unit 400.

Next, the head unit 1400 will be described in more detail. It is noted that the head unit 1900 has the same configuration as the head unit 1400. Therefore, a detailed description for the configuration of the head unit 1900 will be omitted.

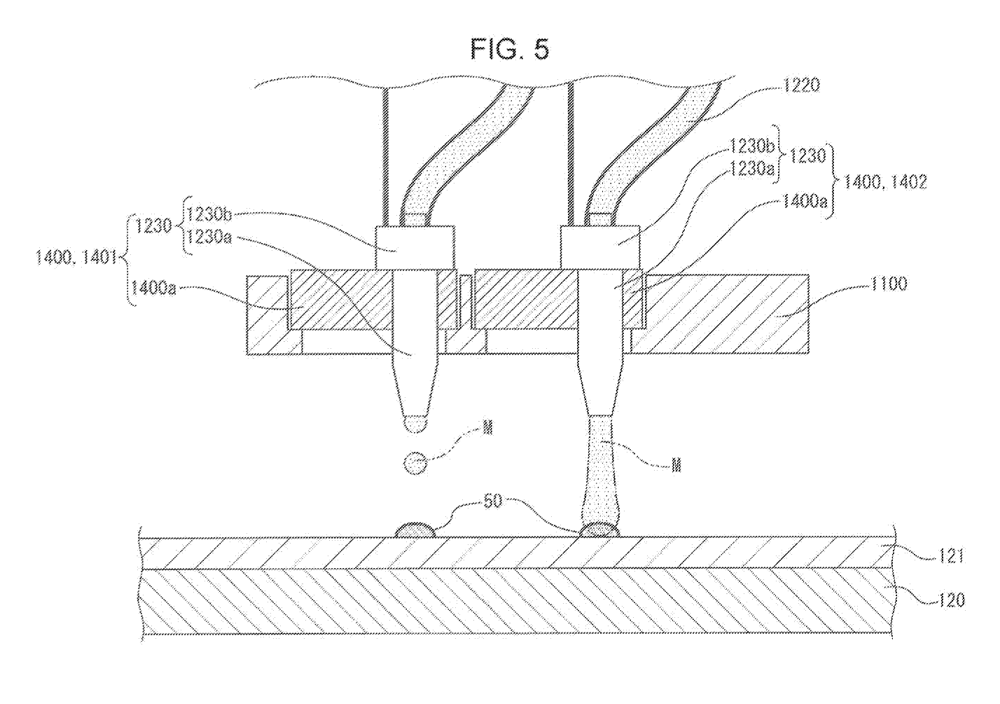

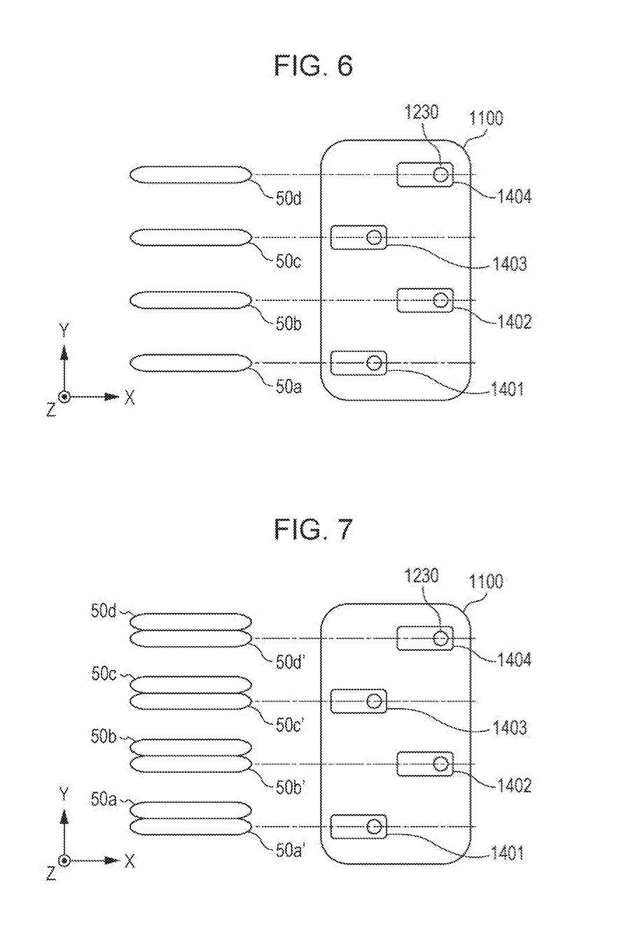

FIG. 5 and FIGS. 6 to 8 show an example of the holding form for a plurality of the head units 1400 and the constituent material discharging sections 1230 held in the head base 1100. Among them, FIGS. 6 to 8 show an external view of the head base 1100 as seen from the direction of an arrow D shown in FIG. 2.

As shown in FIG. 5, the plurality of head units 1400 are held in the head base 1100 by fixing means (not shown). As shown in FIGS. 6 to 8, the head base 1100 of the formation apparatus 2000 according to the present embodiment is provided with the head units 1400 in which, as seen from the bottom of the drawing, four units of a head unit 1401 at the first row, a head unit 1402 at the second row, a head unit 1403 at the third row, and a head unit 1404 at the fourth row are disposed in a staggered (alternating) manner. As shown in FIG. 6, the constituent material is discharged from each of the head units 1400 to form constituent layer constituting portions 50 (constituent layer constituting portions 50a, 50b, 50c, and 50d) while moving the stage 120 in the X direction with respect to the head base 1100. The procedure for forming the constituent layer constituting portions 50 will be described later.

Although not shown, the constituent material discharging section 1230 provided in each of the head units 1401 to 1404 is configured to be connected, via the discharging drive section 1230b and by the supplying tube 1220, to the constituent material supplying unit 1210.

As shown in FIG. 5, in the constituent material discharging section 1230, a material M, which is the constituent material (pasty flowable material) of the three-dimensional shaped article 500, is discharged from the discharging nozzle 1230a onto the sample plate 121 placed on the stage 120. In the head unit 1401, a discharging form in which the material M is discharged in a droplet shape is illustrated, and in the head unit 1402, a discharging form in which the material M is supplied in a continuous body shape is illustrated. The discharging form for the material M may be in a droplet shape or in a continuous body shape, and in the present embodiment, the description is made for a case where the material M is discharged in a droplet shape.

The material M discharged in a droplet shape from the discharging nozzle 1230a flies in almost the gravity direction and lands on the sample plate 121. The stage 120 moves and the constituent layer constituting portions 50 are formed by the landed material M. The assembly of the constituent layer constituting portions 50 is formed as constituent layers 310 (see FIG. 1) of the three-dimensional shaped article 500 to be formed on the sample plate 121.

Next, the procedure for forming the constituent layer constituting portions 50 will be described with reference to FIGS. 6 to 8, and FIGS. 9 and 10.

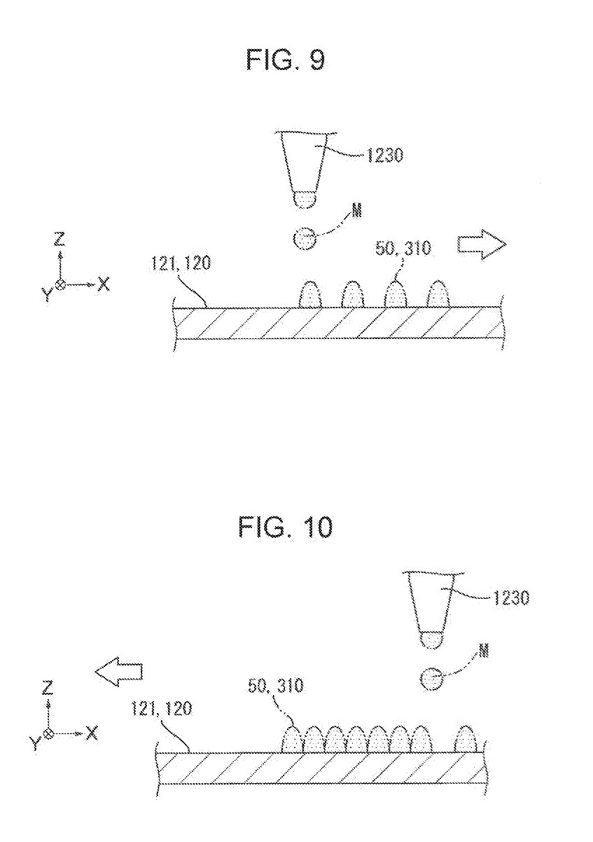

FIGS. 6 to 8 are plan views conceptually explaining the relationship between the disposition of the head units 1400 and the formation form of the constituent layer constituting portions 50 of the present embodiment. FIGS. 9 and 10 are side views conceptually showing the formation form of the constituent layer constituting portions 50.

First, in a case where the stage 120 moves in the +X direction, the material M is discharged in a droplet shape from a plurality of the discharging nozzles 1230a, and the material M is disposed at predetermined positions of the sample plate 121, thereby forming the constituent layer constituting portions 50.

More specifically, first, as shown in FIG. 9, the material M is disposed at a fixed interval at predetermined positions of the sample plate 121 from the plurality of discharging nozzles 1230a while moving the stage 120 in the +X direction.

Next, as shown in FIG. 10, the material M is newly disposed so as to fill the spaces between the materials M disposed at a fixed interval while moving the stage 120 in the −X direction.

However, a configuration where the material M is disposed so as to overlap each other (so as not to be spaced apart) at predetermined positions of the sample plate 121 from the plurality of discharging nozzles 1230a while moving the stage 120 in the +X direction (such configuration indicates not a configuration in which the constituent layer constituting portions 50 are formed by a reciprocating movement of the stage 120 in the X direction but a configuration in which the constituent layer constituting portions 50 are formed by only one directional movement of the stage 120 in the X direction) may be adopted.

By forming the constituent layer constituting portions 50 as described above, as shown in FIG. 6, the constituent layer constituting portions 50 (constituent layer constituting portions 50a, 50b, 50c, and 50d) are formed along one line in the X direction (a first line in the Y direction) of the respective head units 1401, 1402, 1403, and 1404.

Next, in order to form constituent layer constituting portions 50′ (constituent layer constituting portions 50a′, 50b′, 50c′, and 50d′) along a second line in the Y direction of the respective head units 1401, 1402, 1403, and 1404, the head base 1100 is allowed to move in the −Y direction. In a case where the pitch between nozzles is set as P, the amount of movement is such that a movement is made in the −Y direction by P/n (n is a natural number) pitch. In this example, description is made assuming that n is 3.

By performing the same operation as that described above as shown in FIGS. 9 and 10, the constituent layer constituting portions 50′ (constituent layer constituting portions 50a′, 50b′, 50c′ and 50d′) as shown in FIG. 7 are formed along the second line in the Y direction.

Next, in order to form constituent layer constituting portions 50″ (constituent layer constituting portions 50a″, 50b″, 50c″, and 50d″) along a third line in the Y direction of the respective head units 1401, 1402, 1403, and 1404, the head base 1100 is allowed to move in the −Y direction. The amount of movement is such that a movement is made in the −Y direction by P/3 pitch.

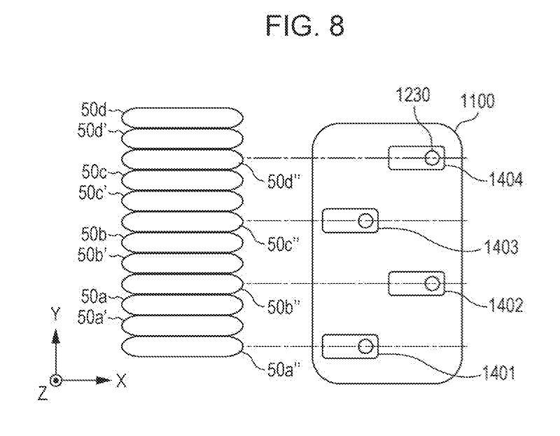

By performing the same operation as that described above as shown in FIGS. 9 and 10, the constituent layer constituting portions 50″ (constituent layer constituting portions 50a″, 50b″, 50c″, and 50d″) as shown in FIG. 8 can be formed along the third line in the Y direction, thereby obtaining the constituent layer 310.

Further, for the material M that is discharged from the constituent material discharging section 1230, it is also possible to cause one unit, or two or more units of the head units 1401, 1402, 1403, and 1404 to discharge and supply the constituent material that is different from another head unit. Thus, by using the formation apparatus 2000 according to the present embodiment, it is possible to obtain a three-dimensional shaped article formed of different materials.

In the layer 501 that is a first layer, before or after forming the constituent layer 310 as described above, it is possible to form the support layer 300, in a similar manner, by discharging the support layer forming material from the support layer forming material discharging section 1730. Also in a case where layers 502, 503, . . . , 50n are formed on the layer 501 such that they are stacked on top of each other, it is possible to form the constituent layer 310 and the support layer 300 in a similar manner.

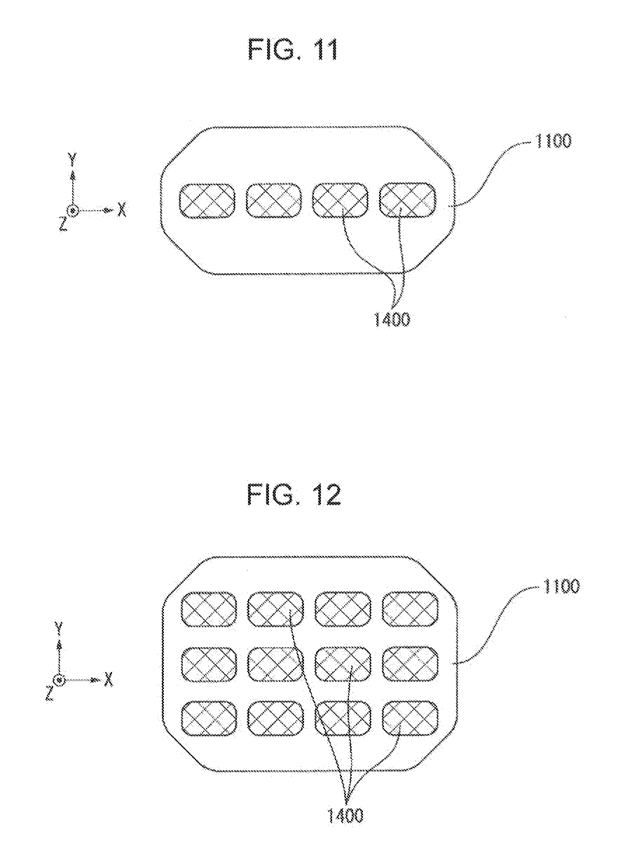

The number and disposition of the head units 1400 and 1900 provided in the formation apparatus 2000 according to the present embodiment described above are not limited to the number and disposition described above. For example, FIGS. 11 and 12 schematically illustrate an example of another disposition for the head units 1400 disposed in the head base 1100.

FIG. 11 shows a configuration obtained by juxtaposing a plurality of head units 1400 in the head base 1100 in the X-axis direction. FIG. 12 shows a configuration by disposing the head units 1400 in the head base 1100 in a lattice pattern. In any case, the number of the head units to be disposed is not limited to the illustrated examples.

Next, the respective three-dimensional shaping pastes as the constituent material and the support layer forming material of this example will be described in detail.

As the constituent material and the support layer forming material, for example, a single powder of magnesium (Mg), iron (Fe), cobalt (Co) or chromium (Cr), aluminum (Al), titanium (Ti), copper (Cu), or nickel (Ni), or a mixed powder of an alloy containing at least one of these metals (maraging steel, stainless steel, cobalt chrome molybdenum, titanium alloy, nickel alloy, aluminum alloy, cobalt alloy, or cobalt chromium alloy), or the like can be used by making it a pasty mixed material containing a solvent and a binder.

Further, it is possible to use a general-purpose engineering plastic such as polyamide, polyacetal, polycarbonate, modified polyphenylene ether, polybutylene terephthalate, or polyethylene terephthalate. In addition, it is also possible to use an engineering plastic (resin) such as polysulfone, polyether sulfone, polyphenylene sulfide, polyarylate, polyimide, polyamideimide, polyetherimide, or polyether ether ketone.

As such, there is no particular limitation on the constituent material and the support layer forming material, and a metal other than the above described metals, a ceramic, a resin, or the like can also be used. Further, silicon dioxide, titanium dioxide, aluminum oxide, zirconium oxide, or the like can be preferably used.

Furthermore, it is also possible to use fibers such as cellulose.

Examples of the solvent include water; (poly)alkylene glycol monoalkyl ethers such as ethylene glycol monomethyl ether, ethylene glycol monoethyl ether, propylene glycol monomethyl ether, and propylene glycol monoethyl ether; acetate esters such as ethyl acetate, n-propyl acetate, isopropyl acetate, n-butyl acetate, and isobutyl acetate; aromatic hydrocarbons such as benzene, toluene, and xylene; ketones such as methyl ethyl ketone, acetone, methyl isobutyl ketone, ethyl n-butyl ketone, diisopropyl ketone, and acetylacetone; alcohols such as ethanol, propanol, and butanol; tetraalkyl ammonium acetates; sulfoxide-based solvents such as dimethyl sulfoxide and diethyl sulfoxide; pyridine-based solvents such as pyridine, γ-picoline, and 2,6-lutidine; and ionic liquids such as tetraalkyl ammonium acetate (for example, tetrabutylammonium acetate), and one selected from these or a combination of two or more thereof can be used.

Examples of the binder include an acrylic resin, an epoxy resin, a silicone resin, a cellulose-based resin, or other synthetic resin, or a polylactic acid (PLA), a polyamide (PA), a polyphenylene sulfide (PPS), or other thermoplastic resin.

Next, an example of the production method for the three-dimensional shaped article carried out by using the formation apparatus 2000 will be described with reference to a flowchart.

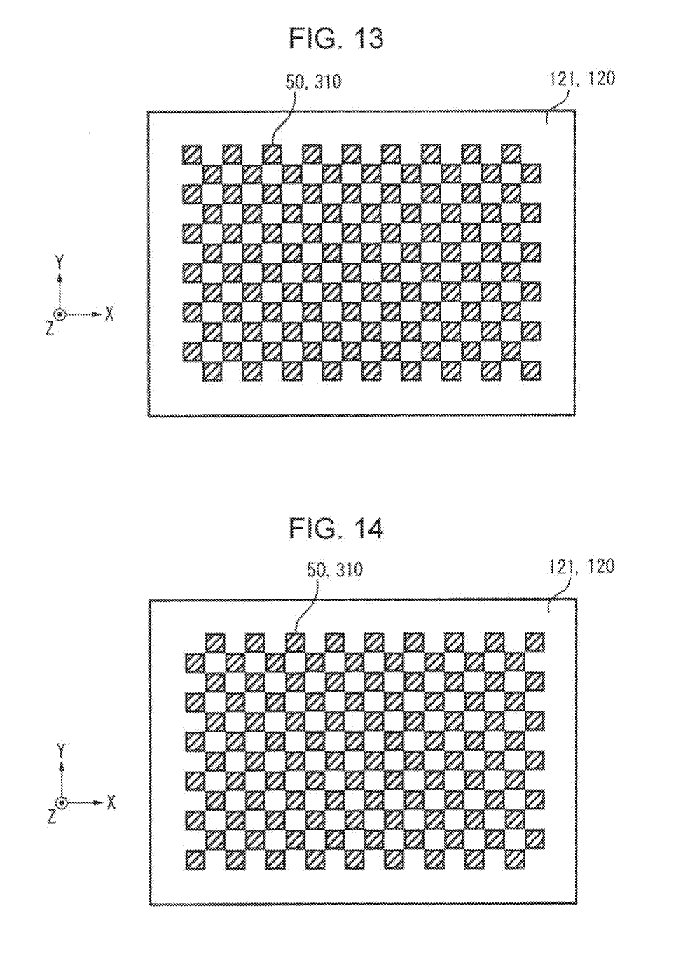

In this case, FIGS. 13 and 14 are schematic views conceptually explaining disposition of a flowable material in a case where the flowable material is ejected onto the stage 120 (sample plate 121) based on the divided pieces of data, in an example of a production method for a three-dimensional shaped article which is performed by using the formation apparatus 2000.

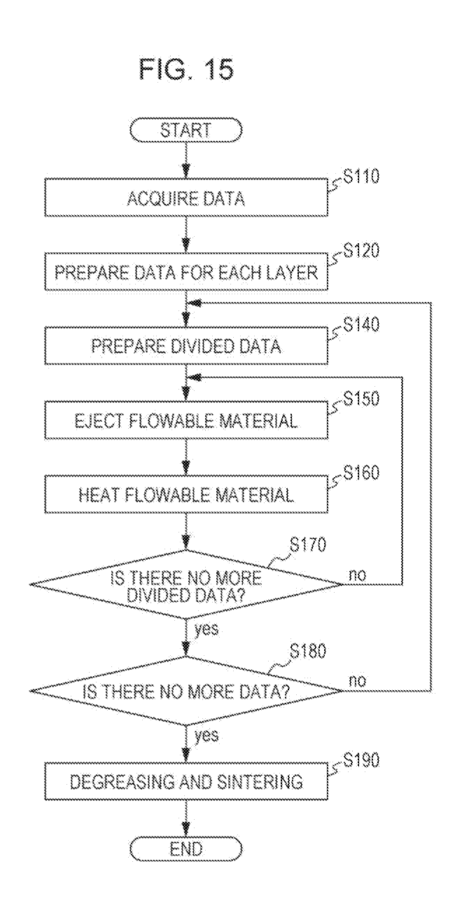

FIG. 15 is a flowchart for the production method for the three-dimensional shaped article according to this example.

As shown in FIG. 15, in the production method for a three-dimensional shaped article of this example, firstly, in step S110, data for the three-dimensional shaped article is acquired. Specifically, for example, data representing the shape of the three-dimensional shaped article 500 is acquired from an application program or the like run on a personal computer.

Next, in step S120, under control of the control unit 400, data for each layer is prepared (generated). Specifically, in the data representing the shape of the three-dimensional shaped article 500, slicing is performed according to the shaping resolution in the Z direction, and bitmap data (sectional data) is generated for each section.

Next, in step S140, under control of the control unit 400, the data for one layer generated in step S120 is divided to prepare (generate) divided pieces of data. In this example, data of a solid pattern having an ejection density of 100% will be described as an example of data for one layer.

In step S140, as shown in FIG. 13, the data for one layer generated in step S120 is divided into a divided piece of data in which the respective masses of the flowable material (constituent layer constituting portion 50) are disposed in a staggered manner with one another (in a so-called checkered pattern) so as to have a size equal to or less than a predetermined threshold as shown in FIG. 13, and a divided piece of data in which the respective masses of the flowable material (constituent layer constituting portion 50) are disposed in a staggered manner with one another so as to have a size equal to or less than a predetermined threshold as shown in FIG. 14. By combining the constituent layer constituting portions 50 shown in FIG. 13 and constituent layer constituting portions 50 shown in FIG. 14, a solid pattern of 100% of the flowable material is formed.

In this example, the data is divided such that both the divided piece of data corresponding to FIG. 13 and the divided piece of data corresponding to FIG. 14 become patterns with an ejection density of 50%. However, the invention is limited to such a dividing method. In addition, the number of divisions is not limited to two.

Next, in step S150, under control of the control unit 400, based on the divided pieces of data generated in step S140, a flowable material (constituent material) is discharged from the constituent material discharging section 1230 (in some cases, the support layer forming material is also discharged from the support layer forming material discharging section 1730) to form the constituent layer constituting portions 50 (constituent layers 310) based on the divided pieces of data.

In this example, the data for one layer generated in step S120 is divided into two divided pieces of data. Thus, for example, in a case of the first step S150 after completion of step S140, the constituent layer constituting portions 50 are formed as shown in FIG. 13. In addition, in a case of the second step S150 after completion of step S140, the constituent layer constituting portions 50 are formed as shown in FIG. 14.

Next, in step S160, under control of the control unit 400, electromagnetic waves (infrared rays) are irradiated from the electromagnetic wave irradiating section 1000 to heat the constituent layer constituting portions 50 formed in step S150, thereby removing (volatilizing) the solvent contained in the flowable material.

In the method for producing a three-dimensional shaped article according to this example, the solvent is removed from the layer of the three-dimensional shaped article 500 by being irradiated with electromagnetic waves from the electromagnetic wave irradiating section 1000 so that the solvent is volatilized. However, the invention is not limited to such a method. For example, the solvent may be removed by using a hot plate or another heating mechanism.

Next, in step S170, a determination is made by the control unit 400 whether the formation of the constituent layer constituting portions 50 based on the divided pieces of data generated in step S140 has been completed. In a case where a determination is made that the formation of the constituent layer constituting portions 50 has not been completed (in a case of the first step S170 after completion of step S140), the process returns to step S150, and in a case where a determination is made that the formation of the constituent layer constituting portions 50 has been completed (in a case of the second step S170 after completion of step S140), step S180 proceeds.

Then, steps S140 to S180 are repeated under control of the control unit 400 until a determination is made in step S180 whether shaping of a stack of the three-dimensional shaped article 500 based on the bitmap data corresponding to each of the layers generated in step S120 is completed.

Then, in step S190, the stack of the three-dimensional shaped article 500 formed in the above step is heated, for example, in a constant temperature bath (not shown), to perform at least one of degreasing and sintering.

Along with the completion of step S190, the production method for the three-dimensional shaped article of this example is completed.

As described above, the method for producing a three-dimensional shaped article according to this example is a method for producing a three-dimensional shaped article in which the three-dimensional shaped article 500 is produced by stacking layers using the formation apparatus 2000 that is an apparatus for producing a three-dimensional shaped article which includes the constituent material discharging section 1230 as an ejecting section capable of ejecting (discharging) a flowable material that contains a powder, a solvent, and a binder which constitute the three-dimensional shaped article 500, based on data; the electromagnetic wave irradiating section 1000 as a heating section for heating the flowable material ejected from the constituent material discharging section 1230; and the control unit 400 as a controlling section for controlling the constituent material discharging section 1230 and the electromagnetic wave irradiating section 1000. Then, data of a layer for one layer of the three-dimensional shaped article 500 out of the data is divided into a plurality of divided pieces of data (step S140), and ejection of the flowable material from the constituent material discharging section 1230 (step S150) and heating by the electromagnetic wave irradiating section 1000 (step S160) are alternately repeated in step S170 based on the divided pieces of data, to form the layer for one layer of the three-dimensional shaped article 500.

That is, in the method of producing a three-dimensional shaped article according to this example, the data of the layer for one layer is divided into a plurality of divided pieces of data to make an ejection density of the flowable material low (to reduce moving efficiency of the binder), and at the same time, every time the flowable material with a low ejection density is formed, the flowable material is heated (to make the binder difficult to move). Therefore, by executing the producing method for the three-dimensional shaped article according to this example, it is possible to prevent the binder from being biased in a three-dimensional manner, and it is possible to prevent the three-dimensional shaped article from being damaged.

In alternatively expressing the above-described matter, the formation apparatus 2000 of this example is an apparatus for producing the three-dimensional shaped article 500 in which the three-dimensional shaped article 500 is produced by stacking layers, the apparatus including the constituent material discharging section 1230 capable of ejecting a flowable material that contains a powder, a solvent, and a binder which constitute the three-dimensional shaped article 500, based on data; the electromagnetic wave irradiating section 1000 for heating the flowable material ejected from the constituent material discharging section 1230; and the control unit 400 for controlling the constituent material discharging section 1230 and the electromagnetic wave irradiating section 1000. The control unit 400 divides data of the layer for one layer of the three-dimensional shaped article 500, out of the data, into a plurality of divided pieces of data, and alternately repeats ejection of the flowable material from the constituent material discharging section 1230 and heating by the electromagnetic wave irradiating section 1000, such that the layer for one layer of the three-dimensional shaped article 500 can be formed.

That is, in the formation apparatus 2000 of this example, the data of the layer for one layer is divided into a plurality of divided pieces of data to make an ejection density of the flowable material low (to reduce moving efficiency of the binder), and at the same time, every time the flowable material with a low ejection density is formed, the flowable material is heated (to make the binder difficult to move). Therefore, in the formation apparatus 2000 of this example, it is possible to prevent the binder from being biased in a three-dimensional manner, and it is possible to prevent the three-dimensional shaped article from being damaged.

In addition, as shown in FIGS. 13 and 14, the control unit 400 of this example divides the data of the layer for one layer into two divided pieces of data such that masses of the flowable material having a predetermined threshold or less (constituent layer constituting portions 50) are disposed in a staggered manner with one another. A movable range of the binder is within a range of one of the masses. That is, in the formation apparatus 2000 of this example, it is possible to form a layer for one layer of the three-dimensional shaped article 500 while reducing a movable range of the binder. Therefore, the formation apparatus 2000 of this example is configured such that it is possible to effectively prevent the binder from being biased in a three-dimensional manner, and it is possible to effectively prevent the three-dimensional shaped article 500 from being damaged.

A size of the mass of the flowable material (constituent layer constituting portion 50) per one shown in FIGS. 13 and 14 can be set in a predetermined manner depending on a type of the flowable material to be used, a size of the droplet per drop to be discharged from the constituent material discharging section 1230, a shape of the three-dimensional shaped article 500 to be produced, and the like. That is, the mass of the flowable material (constituent layer constituting portion 50) per one may be prepared with one drop (one dot) discharged from the constituent material discharging section 1230, and may also be prepared with a plurality of drops (a plurality of dots) discharged from the constituent material discharging section 1230.

In addition, as described above, the formation apparatus 2000 of this example is capable of discharging the flowable material in a droplet shape from the constituent material discharging section 1230 (see FIGS. 5, 9, and 10). Therefore, the formation apparatus 2000 of this example is configured to be able to densely form a layer for one layer of the three-dimensional shaped article 500.

In this case, a heating temperature of the flowable material by the electromagnetic wave irradiating section 1000 in step S160 is not particularly limited, and it is preferable that the heating temperature be equal to or lower than a decomposition temperature of the binder contained in the flowable material.

By setting the heating temperature of the flowable material by the electromagnetic wave irradiating section 1000 to be equal to or lower than the decomposition temperature of the binder, it is possible to prevent the three-dimensional shaped article 500 from being damaged due to decomposition of the binder at the time of heating.

In addition, in a case where the ejection of the flowable material (step S150) and the heating by the electromagnetic wave irradiating section 1000 (step S160) are repeated under control of the control unit 400, it is preferable that at least 50% of the solvent contained in the flowable material be volatilized due to the heating by the electromagnetic wave irradiating section 1000, and then the flowable material be ejected from the constituent material discharging section 1230. By ejecting the flowable material from the constituent material discharging section 1230 after making the binder difficult to move, it is possible to effectively prevent the binder from being biased in a three-dimensional manner, and it is possible to effectively prevent the three-dimensional shaped article 500 from being damaged.

In the method of producing a three-dimensional shaped article shown in FIG. 15, after generating data for each layer in step S120, divided pieces of data are automatically generated in step S130.

However, depending on a shape of the three-dimensional shaped article 500 to be produced, there may be some cases where it is less necessary to generate divided pieces of data (cases where it is difficult for the binder to move even in a case of forming the layer in one ejecting process of the flowable material based on the data of the layer for one layer, such as a case where an ejection density of the flowable material is small by nature or a case where ejection positions of the flowable material are disposed in a staggered manner by nature).

Therefore, the formation apparatus 2000 of this example is configured such that, for each the data of the layer for one layer, a determination can be made by the control unit 400 whether the data is to be divided based on at least one of the ejection density and the ejection position of the flowable material. Therefore, the formation apparatus 2000 according to this example is configured such that, in a case where the binder does not easily move without dividing the data, such as a case where an ejection density of the flowable material is low, priority can be given to a production efficiency (production speed) of the three-dimensional shaped article 500.

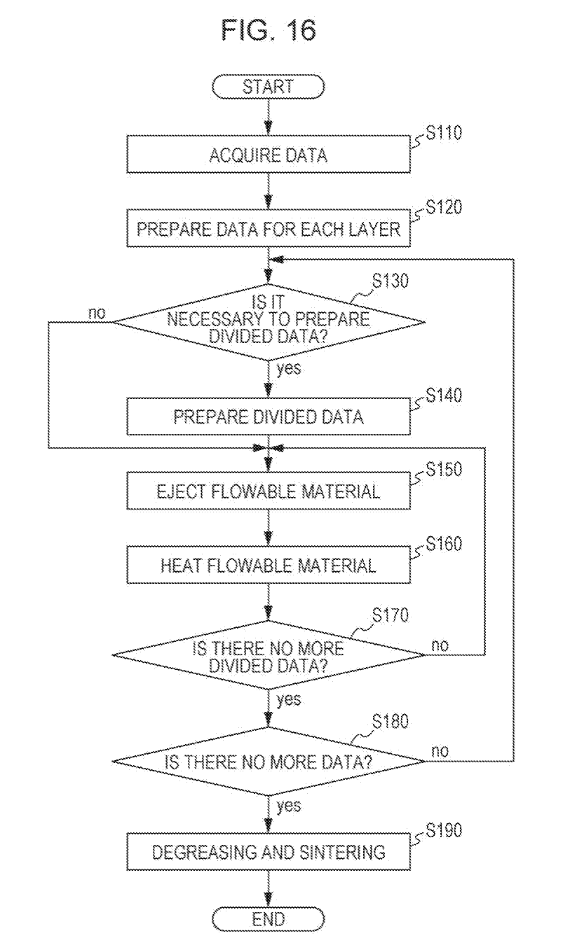

Hereinafter, with respect to an example of a producing method of a three-dimensional shaped article in which the formation apparatus 2000 of this example is used and a determination is made by the control unit 400 whether the data is to be divided based on at least one of the ejection density and the ejection position of the flowable material, descriptions will be made with reference to the flowchart of FIG. 16.

In this case, FIG. 16 is a flowchart of a method of producing a three-dimensional shaped article according to the example, in which S130 (step of making a determination whether divided pieces of data are to be prepared) is executed between step S120 (step of preparing data of a layer for one layer) and S140 (step of preparing divided pieces of data) with respect to the method for producing a three-dimensional shaped article shown in FIG. 15. Since flows from step S110 to step S120 and from step S140 to step S190 are substantially the same as the method for producing a three-dimensional shaped article shown in FIG. 15, detailed descriptions thereof will be omitted.

In the method of producing a three-dimensional shaped article according to this example, during a period from completion of the step of preparing a layer for one layer in step S120 until the step of preparing divided pieces of data proceeds in step S140, in step S130, a determination is made by the control unit 400 whether the data of a layer for one layer is to be divided based on at least one of the ejection density and the ejection position of the flowable material. This is because, in the data of the layer for one layer, in a case where an ejection density of the flowable material is low or positions of the masses of the flowable material (constituent layer constituting portions 50) are sparse, the binder does not easily move without dividing the data.

In a case where a determination is made by the control unit 400 that it is necessary to prepare divided pieces of data in step S130, step S140 proceeds. However, in a case where a determination is made by the control unit 400 that it is not necessary to prepare divided pieces of data in step S130, step S140 is skipped and step S150 proceeds.

Then, in a case where a determination is made in step S130 that it is not necessary to prepare divided pieces of data, an ejection step for the flowable material is executed based on data of a layer for one layer in step S150, and a heating step by the electromagnetic wave irradiating section 1000 is executed in step S160. This causes a determination to be made in step S170 that the divided pieces of data have been completed, and step S180 proceeds.

The step in step S190 and the respective steps in steps S140 to S190 in a case where a determination is made that it is necessary to prepare divided pieces of data in step S130 are the same as the method for producing the three-dimensional shaped article shown in FIG. 15.

The invention is not limited to the examples described above, and can be realized in various configurations without departing from the scope and spirit thereof. For example, the technical features in the examples corresponding to the technical features in the respective embodiments described in the “SUMMARY” section can be appropriately replaced or combined in order to achieve the advantages above described. Further, such a technical feature may be appropriately omitted unless it is described as an essential feature in the specification.

What is claimed is:

1. An apparatus for producing a three-dimensional shaped article in which the three-dimensional shaped article is produced by stacking layers, the apparatus comprising:
an ejecting section capable of ejecting a flowable material that contains a powder, a solvent, and a binder which constitute the three-dimensional shaped article, based on data;
a heating section for heating the flowable material ejected from the ejecting section; and
a controlling section for controlling the ejecting section and the heating section,
wherein the controlling section divides data of the layer for one layer of the three-dimensional shaped article, out of the data, into a plurality of divided pieces of data, and alternately repeats ejection of the flowable material from the ejecting section and heating by the heating section, based on the divided pieces of data, to form the layer for one layer of the three-dimensional shaped article.

2. The apparatus for producing a three-dimensional shaped article according to claim 1,
wherein the controlling section divides the data of the layer for one layer into two divided pieces of data such that masses of the flowable material having a predetermined threshold or less are disposed in an alternating manner with one another.

3. The apparatus for producing a three-dimensional shaped article according to claim 1,
wherein the ejecting section is capable of discharging the flowable material in a droplet shape.

4. The apparatus for producing a three-dimensional shaped article according to claim 1,
wherein, for each data of the layer for one layer, the controlling section is capable of determining whether the data is to be divided based on at least one of an ejection density and an ejection position of the flowable material.

5. The apparatus for producing a three-dimensional shaped article according to claim 1,
wherein a heating temperature of the heating section is equal to or lower than a decomposition temperature of the binder.

6. The apparatus for producing a three-dimensional shaped article according to claim 1,
wherein in a case where the ejection of the flowable material and the heating by the heating section are repeated, the controlling section causes at least 50% of the solvent contained in the flowable material to be volatilized due to the heating by the heating section, and then causes the flowable material to be ejected from the ejecting section.

7. A method for producing a three-dimensional shaped article in which the three-dimensional shaped article is produced by stacking layers using an apparatus for producing a three-dimensional shaped article which includes an ejecting section capable of ejecting a flowable material that contains a powder, a solvent, and a binder which constitute the three-dimensional shaped article, based on data; a heating section for heating the flowable material ejected from the ejecting section; and a controlling section for controlling the ejecting section and the heating section, the method comprising:
dividing data of the layer for one layer of the three-dimensional shaped article, out of the data, into a plurality of divided pieces of data; and
alternately repeating ejection of the flowable material from the ejecting section and heating by the heating section, based on the divided pieces of data, to form the layer for one layer of the three-dimensional shaped article.
